(19) United States
(12) Patent Application Publication
(10) Pub. No.: US 2026/0031370 A1
(43) Pub. Date: Jan. 29, 2026

(54) FUEL CELL STACK

(71) Applicant: POWERCELL SWEDEN AB, 41 834 Gothenburg (SE)

(72) Inventor: Oskar EKBLAD, Gothenburg (SE)

(73) Assignee: POWERCELL SWEDEN AB, 41 834 Gothenburg (SE)

(21) Appl. No.: 18/994,304

(22) PCT Filed: Jul. 5, 2023
(86) PCT No.: PCT/SE2023/050706

§ 371 Date: Jan. 14, 2025

(30) Foreign Application Priority Data
Aug. 3, 2022 (SE) 2250948-3

(51) Int. Cl. H01M 8/0297; H01M 8/1004; H01M 8/242; H01M 8/2475; H01M 8/248

(52) U.S. Cl. CPC H01M 8/0297; H01M 8/1004; H01M 8/242; H01M 8/2475; H01M 8/248

(57) ABSTRACT

A fuel cell stack is provided which includes at least a fuel cell stack body with a plurality of unit fuel cells, wherein each unit fuel cell includes a bipolar plate and a membrane electrode assembly, which are alternatingly stacked in a stacking direction, a first and second terminal plate sandwiching the fuel cell stack body, wherein the first and second terminal plate are adapted to collect the electric energy generated by the fuel cell stack body, a first and second end plate which sandwich the first and second terminal plate, and a housing, wherein the housing includes at least a bottom plate, a stack enclosure configured to cover the side faces of the fuel cell stack, and a top plate, wherein the first end plate is configured as the bottom plate of the housing and is provided with at least one protruding connection element which protrudes laterally from the first end plate and is configured to connect the stack enclosure to the first end plate.

### BACKGROUND AND SUMMARY

The present invention relates to a fuel cell stack.

Usually, a fuel cell stack comprises a stack body including a plurality of membrane electrode assemblies (MEAs), which are separated by so called bipolar plates (BPP), a pair of terminal plates collecting the electric current produced by the stack body, and a pair of endplates sandwiching the terminal plates. Typically, an insulation plate is provided between each of the terminal plate and the adjacent endplate to insulate each terminal plate from the adjacent endplate.

The bipolar plates themselves usually comprise at least two electrically conducting metal plates, so called flow field plates, which are placed on top of each other and have a flow field for the reactants at one side and a flow field for a cooling fluid on the other side. Thereby, the cooling fluid flow fields are facing each other, wherein the reactant fluid flow fields face the MEAs. Each bipolar plate and/or membrane electrode assembly comprises a fuel, oxidant, and coolant inlet manifold, and a fuel, oxidant, and coolant outlet manifold. In the assembled stack, each of the manifold forms a tubelike channel, which extends through the fuel cell stack body and conveys the respective streams to and from the fuel cell stack. The flow field of each plate forms an active area in which electric energy is generated, wherein the active area is disposed between the inlet and outlet manifolds of each unit fuel cell.

Moreover, in order to provide touch protection and/or protection from environmental influences like water and/or dirt, the fuel cell stack is enclosed in a housing which comprises a bottom plate, a top plate, as well as side walls, wherein sealing elements may be provided between the different elements of the housing to achieve a hermetically sealed environment for the fuel cell stack within the housing that ensures a safe and stabile operation of the fuel cell stack.

However, due to the number of different components, a typical fuel cell stack can get quite heavy. Furthermore, since the components have to be manufactured with, depending on the component, narrow tolerances to ensure the proper functioning of the fuel cell stack, and assembled, the manufacturing of the fuel cell stack can be costly and work intensive.

It is desirable to provide a fuel cell stack which is lighter and can be manufactured in an easy and cost-efficient manner.

In the following, a fuel cell stack is provided that comprises a fuel cell stack body with a plurality of unit fuel cells. Each unit fuel cell comprises a bipolar plate and a membrane electrode assembly, which are alternatingly stacked in a stacking direction. Thereby each bipolar plate and/or membrane electrode assembly may comprise at least fuel, oxidant, and coolant inlet manifolds, and at least fuel, oxidant, and coolant outlet manifolds. Particularly, the manifolds may form respective tubelike channels extending through the fuel cell stack body for providing the respective streams to and from the fuel cell stack, wherein each of the unit fuel cells has an active area in which electric energy is generated, wherein the active area is disposed between the inlet and outlet manifolds of each unit fuel cell.

The fuel cell stack further includes a first and second terminal plate sandwiching the fuel cell stack body, wherein the first and second terminal plate are adapted to collect the electric energy generated by the fuel cell stack body. Also, the fuel cell stack comprises a first and second end plate which sandwich the fuel cell stack body. Thereby, at least one of the end plates may comprise at least one inlet opening and at least one outlet opening, wherein the at least one inlet opening is aligned with one or more of the inlet channels, and the at least one outlet opening is aligned with one or more of the outlet channels. For example, the at least one end plate may comprise at least fuel, oxidant, and coolant inlet openings, and at least fuel, oxidant, and coolant outlet openings. Furthermore, an insulation plate may be provided between one of the terminal plates and the adjacent end plate.

In addition, the fuel cell stack includes a housing having at least a bottom plate, a stack enclosure configured to cover the side faces of the fuel cell stack, and a top plate. In particular, the top plate may be connected to the stack enclosure or may be formed integral with the stack enclosure. The stack enclosure may be formed as a hollow box or may be formed by a plurality of separate side walls that are connected to one another to form the hollow box.

In order to reduce the number of components of the fuel cell stack and a complexity of the assembly process of the fuel cell stack, the first end plate is configured as the bottom plate of the housing and is provided with at least one protruding connection element which protrudes laterally from the first end plate and is configured to connect the stack enclosure to the first end plate. This allows to omit the bottom plate of the housing such that the overall fuel cell stack has less weight and less parts, which makes the assembly process simpler and the finished fuel cell stack lighter and saves costs. Advantageously, the second end plate may be further configured as a top plate of the housing. This reduces the number of components and thereby the weight of the fuel cell stack even further.

Furthermore, the first end plate may be provided with a plurality of protruding connection elements. The plurality of protruding connection elements may be discretely disposed around a perimeter of the first end plate. This has the advantage that the stack enclosure can be securely fixed to first end plate.

Alternatively, the at least one protruding connection element may be configured as a flange extending along the entire perimeter of the first end plate. This has the advantage that the stack enclosure can be fixed evenly around the first end plate. Further this allows for a simplified sealing of the housing against external contaminants, as will be explained further below.

Moreover, the at least one protruding connection element may comprise at least one fastening interface for fixing the stack enclosure to the at least one protruding connection element and thereby to the first end plate. This allows to further fasten the stack enclosure to the first end plate. Preferably, the fastening interface may be configured to detachably fasten the stack enclosure to the protruding element. The has the advantage that the housing can be easily detached for accessing the fuel cell stack, for example for maintenance, and reattached thereafter. The fastening interface may be configured to force and/or form fit the stack enclosure to the protruding connection element. For example, the fastening interface may be a groove, a clamping element, a latch, a snap tag, a lug, and/or a hole in the protruding connection element, such as a threaded through hole or a threaded blind hole, or a through hole through which a fastening element can be passed.

According to a further embodiment, at least one sealing element is provided which is configured to provide a seal between the at least one protruding connection element and the stack enclosure. This allows to achieve a sealed environment for the fuel cell stack within the housing that ensures a safe and stabile operation of the fuel cell stack. More specifically, the stack enclosure may abut on top of the at least one protruding connection element or on a side face of the at least one protruding connection element. In case the stack enclosure abuts on the top of the at least one protruding connection element, the at least one sealing element can be arranged between the stack enclosure and the protruding connection element in such a way that the at least one sealing element is compressed by gravity, which improves the sealing between the stack enclosure and the end plate or more specifically the protruding connection element. However, it is also possible to compress the at least one sealing element with other means. For example, a fastening element that fixes the stack enclosure to the protruding connection element may be further configured to compress the at least one sealing element. Thus, even in a case in which the stack enclosure abuts on a side face of the protruding connection element, the sealing between stack enclosure and the protruding connection element can be improved by compressing the at least one sealing element with the aid of the fastening element.

Furthermore, the at least one sealing element is arranged at the at least one protruding connection element and/or at the stack enclosure. Preferably, the at least one sealing element is fixed to the protruding connection element or the stack enclosure. For example, the at least one sealing element may be permanently or detachably fixed to the protruding connection element or the stack enclosure. This has the advantage that the at least one sealing element is fixed in place.

Moreover, the at least one sealing element may be a continuous sealing element. Particularly, in combination with the flange, this allows for an improved hermetic sealing of the fuel cell stack within the housing. In case no hermetic sealing of the housing is necessary, for example if only a touch protection is required, it is further possible to provide a plurality of discrete sealing elements. These elements may preferably interact with the discrete protruding connection elements.

Preferably, the at least one sealing element is arranged in a groove. Furthermore, the at least one sealing element may be fixed to the protruding connection element, particularly the flange, or the stack enclosure with friction force, press-fitted, attached with an adhesive, and/or molded. For example, the at least one sealing element may comprise a U-shape that can be imposed on a rim of the stack enclosure. Also, the at least one sealing element may be molded, clamped, and/or glued.

Moreover, the at least one protruding connection element may include a groove. The groove may be configured to receive a part of the stack enclosure such as a rim of the stack enclosure and/or the at least one sealing element. This has the advantage that a position of the stack enclosure and/or a position of the at least one sealing element on the first end plate can be aligned and/or fixed. Preferably, the groove may be deep enough to also include the at least one sealing element. This can improve the hermetic sealing of the fuel cell stack within the housing. Alternatively, the groove may only receive the at least one sealing element.

According to a further embodiment, the end plate comprises a base portion and a step portion, wherein the at least one protruding connection element is arranged at the base portion, and wherein step portion comprises input and output ports and/or terminals for operation of the fuel cell stack. For example, the input and output ports and terminals may include inlet openings for the reactants and/or coolants, outlet openings for the reactants and/or coolants, at least one output terminal for the generated electrical energy and/or at least one terminal for monitoring the fuel cell stack. Preferably, the step portion is recessed by a predetermined amount with respect to the base portion. This allows to provide enough space between the stack enclosure and components of the fuel cell stack that are arranged at the step portion such as compression elements that may be provided for compression the fuel cell stack.

Preferably, at least the first end plate comprises at least one reinforcing element, particularly for reinforcing the first end plate against deformation forces. In particular, the at least one reinforcing element may be embedded in first end plate. For example, the at least one reinforcing element may be over-molded with or inserted into a material of the first end plate. Preferably, the at least one reinforcing element is made of metal, such as a metal rod or a metal tube. This may increase a resistance of the first end plate against deformation forces. For example, the at least one reinforcing element may be a hollow or massive element. Also, the at least one reinforcing element may be a profiled element and/or may comprise openings into which the material forming the end plate may enter.

In addition or alternatively, the at least one reinforcing element may be a frame having at least one bar with a circular, triangular, rectangular, oval, or polygonal shaped cross-section. Preferably, the at least one reinforcing element is arranged in the step portion of the first end plate. Furthermore, the reinforcing element may be adapted to serve as an anchor point for anchoring the compression element which is configured to compress the fuel cell stack in the stacking direction. This has the advantage that the compression element can be directly attached to a stable structure of the end plate.

According to a further embodiment, at least the first end plate is made of an electrically insulating material. By making the first end plate from an electrically insulating material, the first end plate can advantageously be arranged at least partially in direct contact with the terminal plate and an additional insulation plate can be omitted. Thus, the number of components can be further reduced and consequently the assembly process can be simplified as less parts have to be assembled. Since the end plate itself may be at least partly made from an electrically insulating material, there is no risk for short circuits even if the terminal plate is in direct contact with the end plate.

In addition or alternatively, the at least one end plate may be at least partially coated with the electrically insulating material in a region being in direct contact with the adjacent terminal plate. For example, the end plate may be made at least partially out of metal, which is coated with the electrically insulating material. This has the advantage that the metal can provide the necessary strength and/or stability which is needed for the end plate while the electrically insulating material forms the coating for providing the electrical insulation.

Furthermore, the plastic material may be a fiber-reinforced plastic material. A fiber-reinforced plastic material has the advantage that it can provide more strength and/or stability than a plastic material while also having electrically insulating properties. For example, the fiber-reinforced plastic material may be a fiber glass reinforced molding compound, a fiber glass reinforced epoxy, a fiber glass reinforced polyester, and/or a fiber glass reinforced phenolic molding compound.

Preferably, the electrically insulating material is a moldable material, wherein preferably the at least one end plate is molded. Advantageously, the end plate may be formed by a molding process such as injection molding. This allows for a cost-efficient manufacturing process. For example, the electrically insulating material may be a composite plastic, a thermoset composite, and/or a phenolic plastic. A thermosetting plastic material has the advantage that it does not change its shape even if it is exposed to heat.

Preferably, the at least one end plate comprises a recess, wherein the recess is formed in a surface of the end plate facing the adjacent terminal plate, and wherein a size of the recess is dimensioned for receiving the terminal plate. This allows to reduce an overall height of the fuel cell stack. Moreover, a depth of the recess may also be designed such that an entire height of the terminal plate can be received in the recess. Alternatively, the depth of the recess may be designed such that the height of the terminal plate is only partially incorporated in the recess.

Moreover, the size and/or depth of the recess may be dimensioned such that the recess is also adapted to incorporate a heating element configured to heat the fuel cell stack body. The heating element may be configured to provide the fuel cell stack or parts of the fuel cell stack with thermal energy in order to compensate for a heat loss occurring during the operation of the fuel cell stack or for heating up the fuel cell stack during start up. By placing the heating element in the recess of the end plate as well, the height of the fuel cell stack is further reduced.

According to a further embodiment, at least the first end plate is at least partially in direct contact with the terminal plate, and the at least one end plate comprises at least one surface structure element which is adapted to avoid any current creepage between the terminal plate and conductive parts of the end plate. Although the end plate is electrically isolating, there is a chance that electrical creepage may occur. Electrical creepage or leakage current is an uncontrollable and undesirable current, which flows along the surface of an insulating material between two conductors. The shortest path that these currents flow on the insulating material surface is called creepage distance. These fault currents on the insulating material surface may cause changes in the insulating material over time.

For example, the at least one surface structure element may be arranged adjacent to a conductive element. Preferably, the at least one surface structure comprises at least one rib and/or groove and/or a plurality of ribs and/or grooves. In addition or alternatively, the at least one structure element is disposed at a periphery of the at least one end plate and/or at a recess formed in the at least one end plate. The conductive element may be the terminal plate, a reinforcing element, and/or any other metallic parts. Also, there may be more than one surface structure element provided on the at least one end plate.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only. The figures show:

FIG. 1: a schematic perspective exploded view of a fuel cell stack according to an embodiment,

FIG. 2: a schematic perspective view of an end plate of the fuel cell stack of FIG. 1, and

FIG. 3: a side view of the fuel cell stack.

In the following same or similar functioning elements are indicated with the same reference numerals.

### DETAILED DESCRIPTION

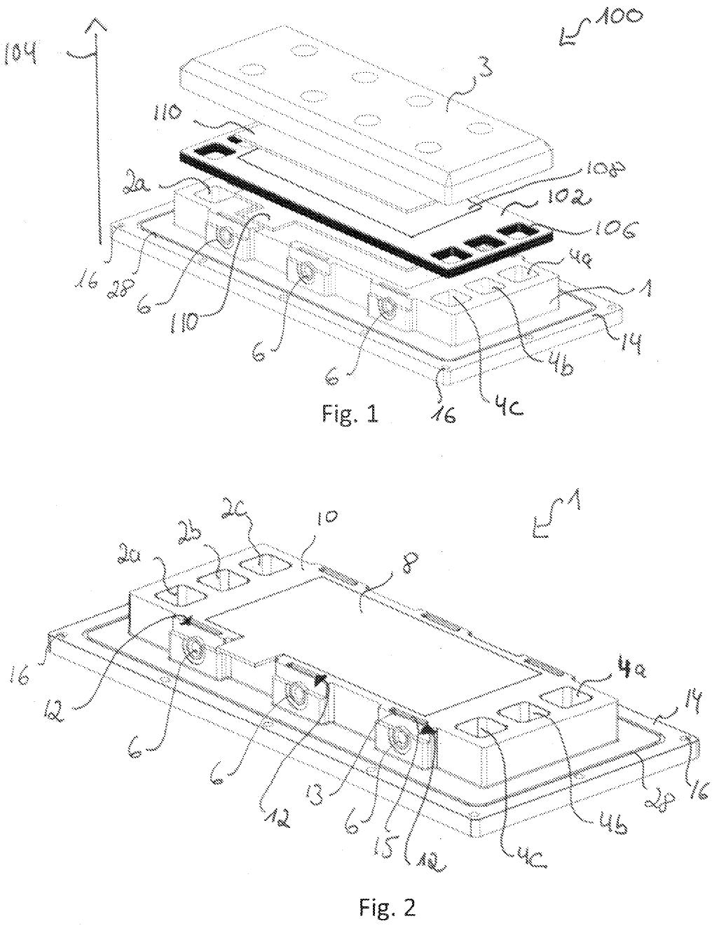

FIGS. 1 to 3 show a fuel cell stack 100 according to an embodiment. The fuel cell stack comprises a fuel cell stack body 102 with a plurality of unit fuel cells. Each unit fuel cell comprises a bipolar plate and a membrane electrode assembly, which are alternatingly stacked in a stacking direction 104, wherein each bipolar plate and/or membrane electrode assembly may comprise at least fuel, oxidant, and coolant inlet manifolds, and at least fuel, oxidant, and coolant outlet manifolds. The manifolds may form respective tubelike channels 106 extending through the fuel cell stack body 102 for providing the respective streams to and from the fuel cell stack 100. Each of the unit fuel cells has an active area 108 in which electric energy is generated, wherein the active area 108 is disposed between the inlet and outlet manifolds of each unit fuel cell.

The fuel cell stack 100 further includes a first and second terminal plate 110 sandwiching the fuel cell stack body 102. The first and second terminal plate 110 are adapted to collect the electric energy generated by the fuel cell stack body 102 in the active area 108. Also, the fuel cell stack comprises a first end plate 1 and a second end plate 3 which sandwich the fuel cell stack body 102.

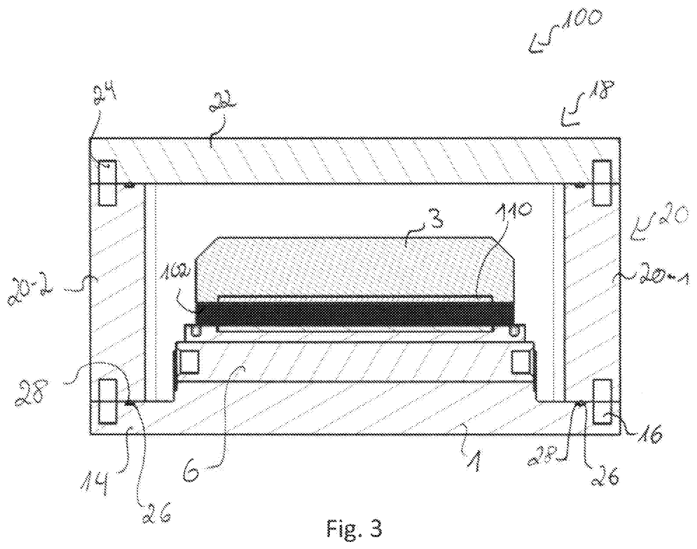

Furthermore, the fuel cell stack 100 is equipped with a housing 18 (FIG. 3) which may serve as a touch and/or environment protection. The housing 18 comprises a stack enclosure 20 configured to cover the side faces of the fuel cell stack 100, and a top plate 22. The bottom plate of the housing 18 is formed by the first end plate 1, as can be seen from FIG. 3. The top plate 22 is connected to the stack enclosure 20 with fastening interfaces 24 and the stack enclosure 20 is formed by a plurality of separate side walls 20-1, 20-2 that are connected to one another to form a hollow box. Alternatively, the stack enclosure 20 may be formed as a hollow box and/or the top plate 22 may be formed integral with the stack enclosure 20 or the second end plate 3 may be configured as the top plate 20.

In order to also serve as the bottom plate for the housing 18, the end plate 1 is provided with a protruding connection element 14 which protrudes laterally from the first end plate 1 and is configured to connect the housing 18 to the first end plate 1. In the described embodiment, the protruding connection element is a flange 14, which surrounds a perimeter of the end plate 1. Alternatively, particularly, if only a touch protection is required, the first end plate 1 may be provided with a plurality of separate protruding connection elements, wherein the plurality of protruding connection elements is disposed around a perimeter of the first end plate 1.

In the described embodiment, the housing 18 abuts on top of the flange 14, as can be seen in FIG. 3. In order to attach the housing 18 to the end plate 1, the flange 14 has a plurality of fastening interfaces 16 for securing the housing 18 on the end plate 1. In the shown embodiment, the fastening interface 16 are threaded blind holes that are provided in the flange 14 in the stacking direction 104. However, the fastening interface 16 may also be a threaded through hole or a through hole through which a fastening element can be inserted. Alternatively, the stack enclosure 20 may about on a side face of the flange 14. In this case, the threaded blind holes serving as the fastening interface may be provided perpendicular to the stacking direction 104 in the side face of the flange 14.

To ensure a hermetic sealing of the fuel cell stack, a continuous sealing element 26 is provided to seal between the flange 14 and the housing 18 or stack enclosure 20, respectively. In the illustrated embodiment, the sealing element 26 is arranged in a groove 28 provided in the flange 14. Alternatively, the sealing element 26 may be fixed to the protruding connection element 14 or the stack enclosure 20. For example, the sealing element 26 may be fixed with friction force, press-fitted, attached with an adhesive, molded, clamped, and/or glued. As can be seen from FIG. 3, the stack enclosure 20 abuts on top of the flange 14 such that the sealing element 26 is compressed by the weight of the stack enclosure 20 due to gravity even before the stack enclosure 20 is fastened to the first end plate 1.

As can be seen, the end plate 1 has a T-shape with a base portion formed by the flange 14 and a step portion, wherein the step portion comprises input and output ports and/or terminals for operation of the fuel cell stack 100 such as the input and output openings 2a, 2b, 2c, 4a, 4b, 4c. More particularly, the first end plate 1 has fuel, oxidant, and coolant inlet openings 2a, 2b, 2c and fuel, oxidant, and coolant outlet openings 4a, 4b, 4c.

As can be seen in FIG. 1, the inlet openings 2a, 2b, 2c and the outlet openings 4a, 4b, 4c are aligned with inlet and outlet channels 106 extending through the fuel cell stack body 102 for providing the respective streams to and from the fuel cell stack 100. In this case, the second end plate 3 is adapted to terminate the inlet and outlet channels 106. Alternately, the inlet openings 2a, 2b, 2c and the outlet openings 4a, 4b, 4c may be divided between the first and second end plate 1, 3.

As can be seen from FIG. 1, the first end plate 1 and the second end plate 3 are at least partially in direct contact with the terminal plates 110. In order to avoid any short circuits between the terminal plates 110 and the first and second end plate 1, 3, the end plates 1, 3 are made of a plastic material for electrically insulating the end plates 1, 3. Alternatively, an insulation plate made from an electrically insulating material may be provided between the end plate 1, 3 and the terminal plates 110.

The plastic material forming the first end plate 1 may be a moldable plastic material, such that the end plate 1 can be formed by a molding process such as injection molding

Moreover, in the illustrated embodiment, the end plate 1 includes three reinforcing elements 6, which are embedded in the plastic material. However, any other number of reinforcing elements 6 may be chosen, depending on the size of the end plate 1 and/or expected load the end plate 1 will be subjected to. As can be seen in FIG. 3, the reinforcing elements 6 are cylindrical rods that extend through the end plate 1. For example, the reinforcing elements 6 may be over-molded with the electrically insulating material. Alternatively, the reinforcing elements 6 may be inserted in the end plate 1.

Alternatively, the reinforcing elements 6 may form a frame having metal bars with a circular, triangular, rectangular, oval, or polygonal shaped cross-section. Depending on the size of the end plate 1 and/or the expected load on the end plate 1, the reinforcing elements may be hollow elements or massive elements. Also, the reinforcing elements 6 may be profiled and/or may comprise openings into which the material forming the end plate 1 may enter. Of course, different types of reinforcing elements 6 may be used in one end plate 1.

The end plate 1 shown in this embodiment is made from a plastic material, which allows to omit an additional insulation plate between the end plate 1 and the adjacent terminal plate 110. As can be further seen in the illustrated embodiment, the end plate 1 comprises a recess 8 which is formed in a surface 10 of the end plate 1 facing the adjacent terminal plate 110. A size of the recess 8 is dimensioned for receiving the terminal plate 110. For example, a depth of the recess 8 may be designed such that an entire height of the terminal plate 110 can be received in the recess 8. Alternatively, the depth of the recess 8 is such that the height of terminal plate 110 is only partially incorporated in the recess 8.

Furthermore, the end plate 1 is provided with a surface structure element 12 which is adapted to avoid any current creepage between conductive elements such as the terminal plate 110 and conductive parts of the end plate 1. For example, the surface structure element 12 is arranged adjacent to the reinforcing elements 6 which are conductive elements. The surface structure element 12 is formed as a rib 13 and groove 15. In addition or alternatively, at least one structure element 12 may be also arranged in the recess 8.

In summary, providing an end plate that also serves as a bottom plate of a housing allows to omit the bottom plate of the housing and consequently to reduce the number of components in the fuel cell stack. This may reduce the overall weight of the fuel cell stack and may also simplify the assembly process of the fuel cell stack as the number of components is reduced. A further weight and/or component reduction may be achieved by using an end plate that is made of an electrically insulting plastic material which may allow to also omit the insulation plate which is usually provided between the end plate and the terminal plate. Since the end plate is electrically insulating there is no risk for short circuits even if the conductive elements of the terminal plate are in contact with the end plate.

### REFERENCE NUMERALS

1 end plate
2 openings
3 end plate
4 openings
6 reinforcing elements
8 recess
10 surface
12 surface structure element
13 rib
14 protruding connection element
15 groove
16 fastening interface
18 housing
20 stack enclosure
22 top plate
24 fastening interface
26 sealing element
28 groove
100 fuel cell stack
102 fuel cell stack body
104 stacking direction
106 channels
108 active arca
110 terminal plate

1. Fuel cell stack comprising at least
a fuel cell stack body with a plurality of unit fuel cells, wherein each unit fuel cell comprises a bipolar plate and a membrane electrode assembly, which are alternatingly stacked in a stacking direction,
a first and second terminal plate sandwiching the fuel cell stack body, wherein the first and second terminal plate are adapted to collect the electric energy generated by the fuel cell stack body,
a first and second end plate which sandwich the first and second terminal plate, and
a housing, wherein the housing includes at least a bottom plate, a stack enclosure configured to cover the side faces of the fuel cell stack, and a top plate,
wherein the first end plate is configured as the bottom plate of the housing and is provided with at least one protruding connection element which protrudes laterally from the first end plate and is configured to connect the stack enclosure to the first end plate.

2. Fuel cell stack according to claim 1, wherein the at least one protruding connection element comprises at least one fastening interface for securing the stack enclosure to the at least one protruding connection element and thereby to the first end plate.

3. Fuel cell stack according to claims 1, wherein the stack enclosure abuts on top of the at least one protruding connection element or on a side face of the at least one protruding connection element.

4. Fuel cell stack according to claim 1, wherein the at least one protruding connection element includes a groove.

5. Fuel cell stack according to claim 1, wherein at least one sealing element is provided which is configured to provide a seal between the at least one protruding connection element and the stack enclosure, wherein preferably the sealing element is arranged in a groove.

6. Fuel cell stack according to claim 5, wherein the at least one sealing element is arranged at the at least one protruding connection element and/or at the stack enclosure, wherein preferably the at least one sealing element is fixed to the protruding connection element or the stack enclosure.

7. Fuel cell stack according to claim 1, wherein the at least one protruding connection element is configured as a flange extending along the entire perimeter of the first end plate.

8. Fuel cell stack according to claim 1, wherein the first end plate comprises a base portion and a step portion, wherein the at least one protruding connection element is arranged at the base portion, and wherein step portion comprises input and output ports and/or terminals for operation of the fuel cell stack.

9. Fuel cell stack according to claim 1, wherein at least the first end plate comprises at least one reinforcing element, particularly for reinforcing the first end plate against deformation forces.

10. Fuel cell stack according to claim 1, wherein at least the first end plate is made of a plastic material, preferably a fiber-reinforced plastic material.

11. Fuel cell stack according to claim 10, wherein at least the first end plate is at least partially in direct contact with the terminal plate, and wherein the at least one end plate comprises at least one surface structure element which is adapted to avoid any current creepage between the terminal plate and a conductive element of the end plate.
